(19) United States
(12) Patent Application Publication
(10) Pub. No.: US 2025/0204315 A1
(43) Pub. Date: Jun. 26, 2025

(54) ROBOTIC LAWNMOWER WITH INCREASED CUTTING PROPERTIES

(71) Applicant: HUSQVARNA AB, Huskvarna (SE)

(72) Inventors: Martin ALLARD, Huskvarna (SE); Alexander TURESSON, Huskvarna (SE)

(21) Appl. No.: 18/980,018

(22) Filed: Dec. 13, 2024

(30) Foreign Application Priority Data
Dec. 21, 2023 (SE) 2351482-1

(51) Int. Cl. A01D 43/02; A01D 101/00

(52) U.S. Cl. CPC A01D 43/02; A01D 2101/00

(57) ABSTRACT

A front wheel driven robotic lawnmower is adapted to run in a forward running direction, the robotic lawnmower comprising a main body part, a plurality of wheels, a rotatable cutting disc that is driven by a cutter motor, and a control unit. At least two front drive wheels are drivably connected to a corresponding electric drive wheel motor that at least partly is contained in a respective motor housing. A corresponding frontmost part of the motor housings in the forward running direction define a front grass receiving opening, and a corresponding rearmost part of the motor housings in the forward running direction define a rear grass receiving opening. A shortest rear distance between the rearmost parts falls below a shortest front distance between the frontmost parts such that corresponding housing wall parts connecting the frontmost parts and the rearmost part form a funnel-shaped grass guide.

### TECHNICAL FIELD

The present disclosure relates to front wheel driven robotic lawnmower adapted to run in a forward running and comprising a main body part, a plurality of wheels, a rotatable cutting disc that is driven by a cutter motor, and a control unit. At least two front drive wheels are drivably connected to a corresponding electric drive wheel motor that at least partly is contained in a respective motor housing.

### BACKGROUND

Robotic work tools such as for example robotic lawnmowers are becoming increasingly more popular. In a typical deployment a work area, such as a garden, the work area is enclosed by a boundary wire with the purpose of keeping the robotic lawnmower inside the work area. An electric control signal may be transmitted through the boundary wire thereby generating an (electro-) magnetic field emanating from the boundary wire. The robotic lawnmower is typically arranged with one or more sensors adapted to sense the control signal.

Alternatively, or as a supplement, the robotic lawnmower can be equipped with a navigation system that is adapted for satellite navigation as well as navigation by means of a local base station.

The robotic lawnmower is adapted to cut grass on a user's lawn automatically and can be charged automatically without intervention of the user, and does not need to be manually managed after being set once.

The robotic lawnmower comprises a main body part, a plurality of wheels, a control unit and at least one electric motor, where at least one wheel is drivably connected to at least one electric wheel drive motor that extends from the main body part towards the ground. The robotic lawnmower further comprises a grass cutting device in the form of a rotatable cutting disc that is driven by a cutter motor. In case of front wheel driven robotic lawnmowers, where the part of the cutting disc that is positioned closest to the ground is farther away from the ground than the part of the wheel drive motors that is positioned closest to the ground, grass that passes the wheel drive motors and exceeds a certain length is bent before reaching the cutting disc, such that cutting of that efficient cutting of that grass is impaired. One way to solve this problem is to put the wheel drive motors more apart from each other, or increase the drive wheels' diameter. These changes will, however, have a big effect on the overall size of the mower.

It is therefore desired to provide means for ensuring efficient cutting even in these cases.

### SUMMARY

The object of the present disclosure is to provide efficient cutting of relatively long grass for front wheel driven robotic lawnmowers.

This object is achieved by means of a front wheel driven robotic lawnmower adapted to run in a forward running direction and comprising a main body part, a plurality of wheels, a rotatable cutting disc that is driven by a cutter motor, and a control unit. At least two front drive wheels are drivably connected to a corresponding electric drive wheel motor that at least partly is contained in a respective motor housing. A corresponding frontmost part of the motor housings in the forward running direction define a front grass receiving opening, and a corresponding rearmost part of the motor housings in the forward running direction define a rear grass receiving opening. A shortest rear distance between the rearmost parts falls below a shortest front distance between the frontmost parts such that corresponding housing wall parts connecting the frontmost parts and the rearmost part form a funnel-shaped grass guide.

In this manner, the grass that is fed into the robotic lawnmower for cutting is not bent by the motor housings, but instead guided to the cutting disc by the funnel-shaped grass guide without being bent. This is in particular advantageous in case the grass to be cut is relatively long, for example around 10 cm, where the grass normally most surely is bent before the cutting disc. This also means that the robotic lawnmower can be kept small and compact since other solutions to the problem with bent grass involve increasing the distance between the drive wheel motors and the corresponding motor housings, or increasing the drive wheels' diameter.

According to some aspects, those parts of the motor housings that are positioned closest to a ground plane during normal operation touches a first plane that runs parallel to the ground plane, and the part of the cutting disc that is positioned closest to the ground plane during normal operation touches a second plane that is parallel to the first plane. The cutting disc is adjustable and can be positioned such that the second plane is farther from the ground plane than the first plane during normal operation.

In this manner, if needed the cutting disc can be adjusted to handle relatively long grass, that, as mentioned above, is guided to the cutting disc by the funnel-shaped grass guide.

According to some aspects, the robotic lawnmower comprises an underneath that is open towards the ground during normal operation such that the cutting disc can reach the grass to be cut and comprises a semi-enclosed space within which the cutting disc is positioned.

This means that the grass to be cut is guided to the semi-enclosed space by the funnel-shaped grass guide.

According to some aspects, the robotic lawnmower comprises a grass untangling and stabilizing comb structure that comprises a plurality of comb elements that run from the main body part towards ground in front of the front grass receiving opening, in the forward running direction.

This means that the grass that is about to enter the funnel-shaped grass guide first is untangled and stabilized such that it is prepared for first being compressed in the funnel-shaped grass guide and then being cut by the cutting disc.

### BRIEF DESCRIPTION OF THE DRAWINGS

The present disclosure will now be described more in detail with reference to the appended drawings, where:

FIG. 1 shows a perspective side view of a robotic lawnmower;

FIG. 2 shows a schematic overview of the robotic lawnmower;

FIG. 3 schematically illustrates a perspective bottom view of the robotic lawnmower;

FIG. 4 schematically illustrates a bottom view of the robotic lawnmower;

FIG. 5 schematically illustrates a perspective front view of the robotic lawnmower with the main body;

FIG. 6 schematically illustrates a perspective front view of the robotic lawnmower without the main body;

FIG. 7 schematically illustrates a detail of FIG. 6; and

FIG. 8 schematically illustrates a section side view of the robotic lawnmower.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

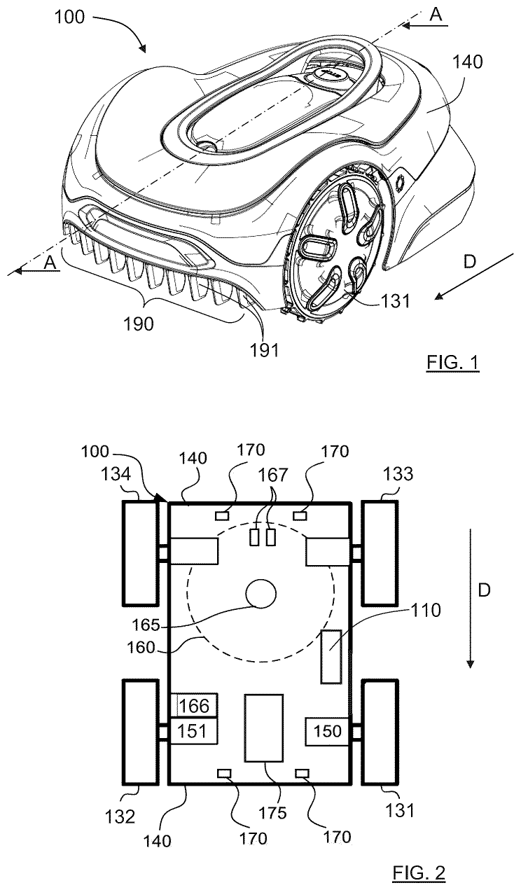

FIG. 1 shows a perspective view of a front wheel driven robotic lawnmower 100, FIG. 2 shows a schematic overview of the robotic lawnmower 100, and FIG. 3 schematically illustrates a perspective bottom view of the robotic lawnmower. The robotic lawnmower 100 is adapted to run a forward travelling direction D and comprises a main body part 140, a plurality of wheels 131, 132, 133, 134, a rotatable cutting disc 160 that is driven by a cutter motor 165, and a control unit 110. At least two front drive wheels 131, 132 are drivably connected to a corresponding electric drive wheel motor 150, 151 that at least partly is contained in a respective motor housing 152, 153. The motor housings 152, 153 having housing wall parts 158, 159 and being positioned opposite each other with respect to the forward running direction D.

In this example the robotic lawnmower 100 has four wheels, two front wheels 131, 132 which constitute drive wheels and two rear wheels 133, 134 which are constituted by swivelable wheels, so-called castor wheels. In this context, the front wheels are those wheels that are positioned frontmost in the forward travelling direction D, and front wheel driven means that the front wheels are driven wheels as disclosed above.

The robotic lawnmower 100 may be a multi-chassis type or a mono-chassis type. A multi-chassis type comprises more than one body parts that are movable with respect to one another. A mono-chassis type comprises only one main body part.

According to some aspects, the wheels 131, 132, 133, 134 extend towards a ground plane G during normal operation of the robotic lawnmower 100, where the ground plane G touches all wheels 131, 132, 133, 134 without intersecting any parts of the robotic lawnmower 100. In this context, normal operation of the robotic lawnmower 100 means normal running of the robotic lawnmower 100.

According to some aspects, the rotatable cutting disc 160 comprises a plurality of pivoting knives 161 (only one indicated), the pivoting knives 161 for example being in the form of a plurality of separate rotating blades 161.

The robotic lawnmower 100 also has at least one rechargeable electric power source such as a battery 166 for providing power to the electric motor arrangement 150 and/or the cutter motor 165. Such a battery 166 can be charged via charging skids 167 at a charging station in a well-known manner.

According to some aspects, the robotic lawnmower 100 comprises a navigation sensor arrangement 175 and an environmental detection sensor arrangement 170. According to some aspects, the navigation sensor arrangement 175 may for example may adapted for satellite navigation by means of GPS (Global Positioning System) or some other Global Navigation Satellite System (GNSS) system, for example using Real Time Kinematic (RTK). In addition to this, the navigation system is adapted for navigation by means of a local base station that can be housed in a charging station and provide a navigation signal that further increases the navigation accuracy. The navigation system may also comprise a boundary wire sensor.

According to some aspects, the environmental detection sensor arrangement 170 comprises at least one of a camera device, a Lidar device, a radar device and an ultrasonic transceiver.

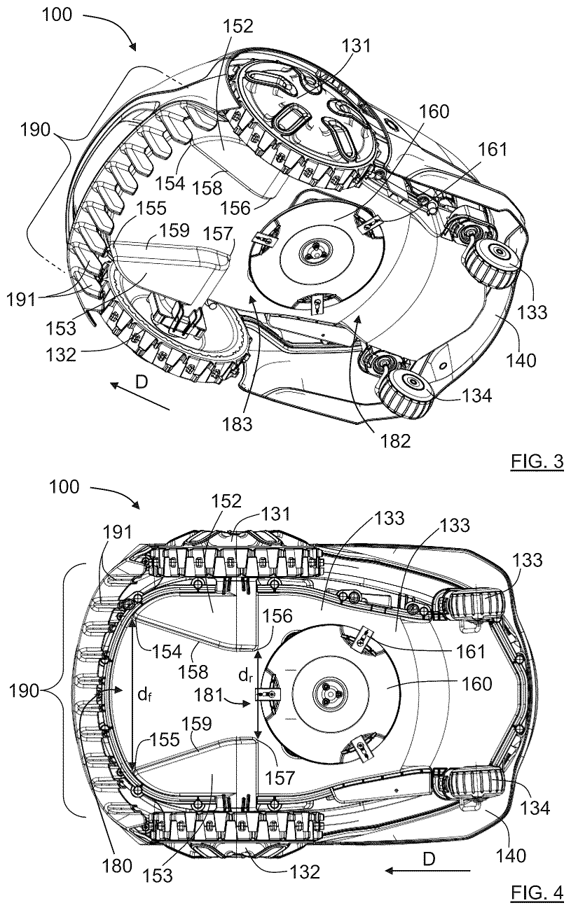

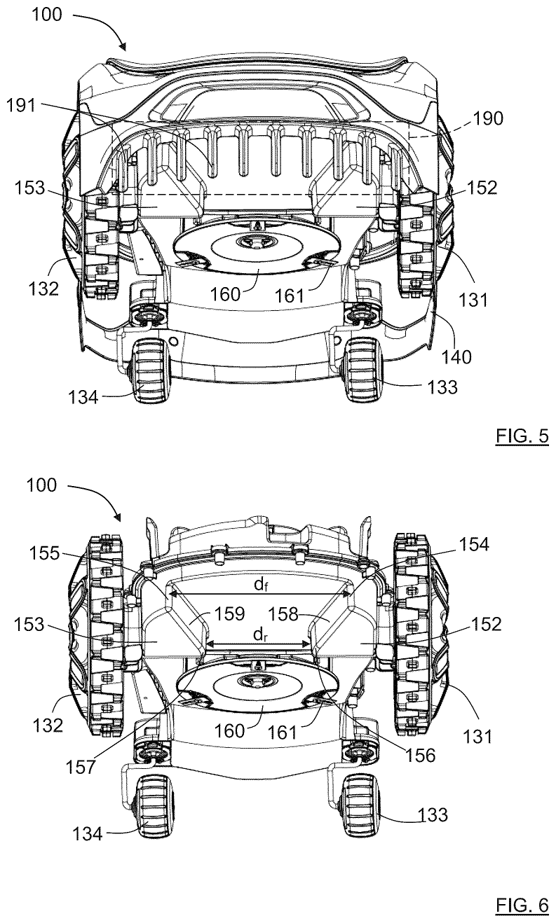

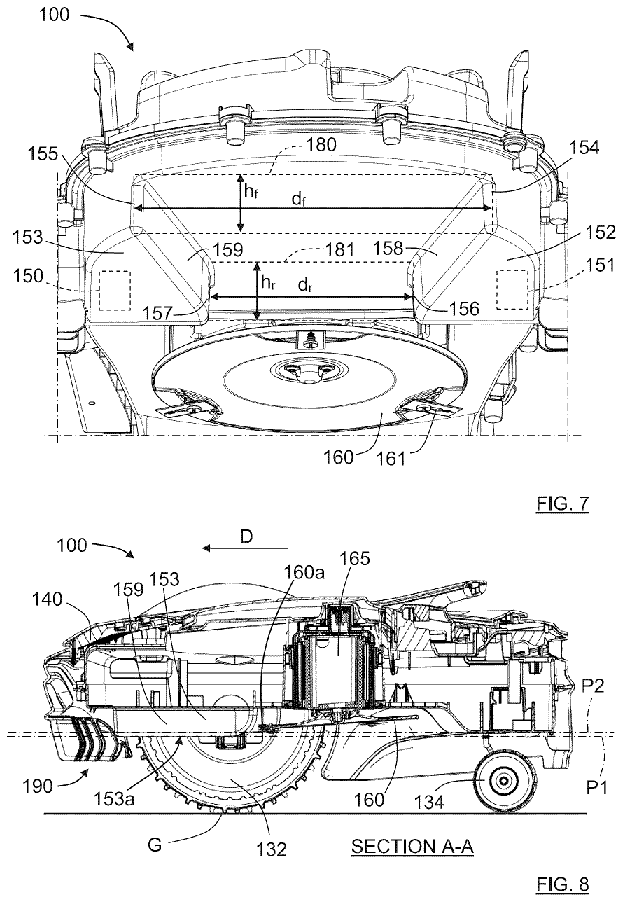

In the following it is also referred to FIG. 4-FIG. 8, where FIG. 4 schematically illustrates a bottom view of the robotic lawnmower, FIG. 5 schematically illustrates a perspective front view of the robotic lawnmower with the main body, FIG. 6 schematically illustrates a perspective front view of the robotic lawnmower without the main body, FIG. 7 schematically illustrates a detail of FIG. 6, and FIG. 8 schematically illustrates a section side view of the robotic lawnmower.

FIG. 7 illustrates an example where a first drive wheel motor 150 that at least partly is comprised in a first motor housing 152 and a second drive wheel motor 151 that at least partly is comprised in a second motor housing 153. This means that the drive wheel motors 150, 151 do not need to completely contained within the corresponding motor housing 152, 153.

A corresponding frontmost part 154, 155 of the motor housings 152, 153 in the forward running direction D define a front grass receiving opening 180, and where a corresponding rearmost part 156, 157 of the motor housings 152, 153 in the forward running direction D define a rear grass receiving opening 181. A shortest rear distance dr between the rearmost parts 156, 157 falls below a shortest front distance d_{f} between the frontmost parts 154, 155 such that corresponding housing wall parts 158, 159 connecting the frontmost parts 154, 155 and the rearmost part 156, 157 form a funnel-shaped grass guide 158, 159.

According to some aspects, the frontmost and rearmost parts 154, 155; 156, 157 are defined by motor housings edges as illustrated in for example FIG. 6.

In this manner, the grass that is fed into the robotic lawnmower 100 for cutting is not bent by the motor housings 152, 153, but instead guided to the cutting disc 160 by the funnel-shaped grass guide 158, 159 without being bent. This is in particular advantageous in case the grass to be cut is relatively long, for example around 10 cm, where the grass normally most surely is bent before the cutting disc 160. By means of the funnel-shaped grass guide 158, 159 according to the present disclosure, the long grass can be guided to the cutting disc 160 without being bent. In this manner, the robotic lawnmower can be kept small and compact since other solutions to the problem with bent grass involve increasing the distance between the drive wheel motors 150, 151 and the corresponding motor housings 152, 153, or increasing the drive wheels' diameter. These changes will have a big effect on the overall size of the robotic lawnmower, which of course is undesirable.

In order to handle long grass in the above manner, the grass receiving openings 180, 181 should have a sufficient height h_{f}, hᵣ, where the front grass receiving opening 180 has a front height h_{f} and where the rear grass receiving opening 181 has a rear height h_{f}. The heights h_{f}, hᵣ can be equal, but need not be equal, and are in the magnitude 8-12 cm, and more preferably in the magnitude 9-11 cm.

According to some aspects, those parts 153a of the motor housings 153, 154 that are positioned closest to the ground plane G during normal operation touches a first plane P1 that runs parallel to the ground plane G. The part 160a of the cutting disc 160 that is positioned closest to the ground plane G during normal operation touches a second plane P2 that is parallel to the first plane P1. The cutting disc 160 is adjustable and can be positioned such that the second plane P2 is farther from the ground plane G than the first plane P1 during normal operation. The cutting disc 160 is thus adjustable such that it can be moved closer to the ground plane G or farther away from the ground plane G.

In this manner, if needed the cutting disc 160 can be adjusted to handle relatively long grass, that, as mentioned above, is guided to the cutting disc 160 by the funnel-shaped grass guide 158, 159.

According to some aspects, the robotic lawnmower 100 comprises an underneath 182 that is open towards the ground G during normal operation such that the cutting disc 160 can reach the grass to be cut and comprises a semi-enclosed space 183 within which the cutting disc 160 is positioned.

This means that the grass to be cut is guided to the semi-enclosed space 183 by the funnel-shaped grass guide 158, 159.

According to some aspects, the robotic lawnmower 100 comprises a grass untangling and stabilizing comb structure 190 that comprises a plurality of comb elements 191 (only a few indicated) that run from the main body part 140 towards ground G in front of the front grass receiving opening 180, in the forward running direction D. This means that the grass that is about to enter the funnel-shaped grass guide 158, 159 first is untangled and stabilized such that it is prepared for first being compressed in the funnel-shaped grass guide 158, 159 and then being cut by the cutting disc 160.

The present disclosure is not limited to the examples provided above, but may vary within the scope of the appended claims. For example, the comb elements 191 can be made in plastic and/or metal, and each may have a varying longitudinal shape.

1. A front wheel driven robotic lawnmower adapted to run in a forward running direction, the robotic lawnmower comprising a main body part, a plurality of wheels, a rotatable cutting disc that is driven by a cutter motor, and a control unit, where at least two front drive wheels are drivably connected to a corresponding electric drive wheel motor that at least partly is contained in a respective motor housing, wherein a corresponding frontmost part of the motor housings in the forward running direction define a front grass receiving opening, and where a corresponding rearmost part of the motor housings in the forward running direction define a rear grass receiving opening, where a shortest rear distance between the rearmost parts falls below a shortest front distance between the frontmost parts such that corresponding housing wall parts connecting the frontmost parts and the rearmost part form a funnel-shaped grass guide.

2. The robotic lawnmower according to claim 1, wherein those parts of the motor housings that are positioned closest to a ground plane during normal operation touches a first plane that runs parallel to the ground plane, and where the part of the cutting disc that is positioned closest to the ground plane during normal operation touches a second plane that is parallel to the first plane, where the cutting disc is adjustable and can be positioned such that the second plane is farther from the ground plane than the first plane during normal operation.

3. The robotic lawnmower according to one of the claim 1, wherein the rotatable disc comprises pivoting knives.

4. The robotic lawnmower according to claim 1, wherein the robotic lawnmower comprises an underneath that is open towards the ground during normal operation such that the cutting disc can reach the grass to be cut and comprises a semi-enclosed space within which the cutting disc is positioned.

5. The robotic lawnmower according to claim 1, wherein the robotic lawnmower comprises a grass untangling and stabilizing comb structure that comprises a plurality of comb elements that run from the main body part towards ground in front of the front grass receiving opening, in the forward running direction.
